(19) United States
(12) Patent Application Publication
(10) Pub. No.: US 2011/0111666 A1
(43) Pub. Date: May 12, 2011

(54) HIGH DENSITY ULTRA-FINE FABRICS

(76) Inventor: Il Han Kim, Seoul (KR)

(21) Appl. No.: 13/002,443

(22) PCT Filed: Jul. 1, 2009
(86) PCT No.: PCT/KR2009/003582

§ 371 Date: Jan. 3, 2011

(30) Foreign Application Priority Data
Jul. 4, 2008 (KR) 10-2008-0064918

(51) Int. Cl. B32B 5/26; D03D 15/00; D05C 17/00

(52) U.S. Cl. 442/239; 442/181; 112/439

(57) ABSTRACT

Provided is a high-density micro fabric, and more particularly, a high-density micro fabric which eliminates the necessity of a cire processing as a post-processing. The high-density micro fabric is woven using warp and weft yarns, wherein a single strand fineness of either of a warp or weft yarn or both of the warp and weft yarns is in the range of 5 denier to 100 denier, a fineness of a monofilament constituting one strand of either of a warp or weft yarn or both of the warp and weft yarns is in the range of 0.1 denier to 1.5 denier, the warp yarn is nylon, polyester, or a composite yarn including nylon and polyester, and the weft yarn is nylon, polyester, or a composite yarn including nylon and polyester, and a high shrinkage nylon yarn, a nylon partially oriented yarn, a nylon spin draw yarn having an elongation at break of 25% or higher, or a water soluble PVA-based yarn that is removed by water during a scouring process or a dyeing process is mixed or arranged with either of a warp or weft yarn, and k value of a shrunken fabric is 22 or greater.

### TECHNICAL FIELD

The present invention relates to a novel high-density micro fabric applicable to a wide range of industrial fields without limitation. The fabric fabricated according to the to present invention can be used for bedding encasements such as bedclothes and padded quilts and covers therefor, covers for furniture, covers for a variety of padding materials, covers for medical appliances, covers for baby products, covers for toys, filters for air cleaners, filters for vacuum cleaners, filters for masks protecting pollen or yellow dust, etc., particularly used to block house dust mites that are harmful allergens and their excrements.

### BACKGROUND ART

It is widely known that a woven fabric with micro pores capable of blocking allergens that cause allergic diseases can be obtained by weaving a fabric using a microfiber having a monofilament fineness of 0.3 d or less as both of warp and weft yarns or as the weft yarn in which a polyester warp yarn and a composite weft yarn consisting of polyester and nylon are used or a polyester warp yarn and a composite weft yarn consisting of polyester as a main component are used, and carrying out a cire processing that is a physical pressing by which pores of the fabric are blocked. Since the 1980s when the production of the microfibers began in Korea, clothes or bedding encasements made of fabrics woven by using the method have been exported. (For example, ‘Hidena’ of Hyosung Co., Ltd.)

In a microfiber woven fabric, gaps A are formed between monofilaments constituting one strand of the microfiber and pores B between strands are inevitably formed as warp-weft intersections by a weaving process. However, the size of the gaps A between monofilaments of one strand are duplicated by cross tension of the warp and weft yarns which occurs during the weaving process. Accordingly, even though a diameter of the monofilament of one strand is 10 μm, the size of the duplicated gaps A may be 3 μm or less. In this light, it is important to regulate the size of pores B in the warp-weft intersections during the weaving process rather than the size of the gaps A, and the size of the pores B may be reduced by increasing the number of strands of the warp and weft yarns.

In addition, adult house dust mites, as one of the main causes for allergic diseases, are 200 to 600 μm in size, eggs of the house dust mites are 40 to 60 μm in size, and excrements thereof are 10 to 40 μm in size. Accordingly, the size of the gaps A should be adjusted to be less than that of the excrements of the house dust mites by using a microfiber having a monofilament fineness of about 10 μm, and the size of the pores B should be also adjusted to be less than that of the excrements of the house dust mites by weaving a fabric with using a microfiber having a desirable fineness in high density. The sizes of the gaps A and the pores B should be maintained not temporarily but permanently without deformation.

Korean Patent No. 10-0365188 discloses a method of reducing the size of pores B of a fabric by using a cire processing as a physical pressing. However, the pore size may be returned to its original size prior to the cire processing by repeated washings and friction with human bodies and the cire processing may cause a feeling of the fabric to become rough or hard. The appropriate number of the warp and weft yarns should also be adjusted according to the single strand fineness of the microfiber, but if the single strand fineness of the microfiber is 100 denier or less, it is difficult to reduce the size of the pores B.

Korean Patent Publication No. 10-2002-0035012 does not clearly recite whether an average pore size of a woven fabric indicates the size of gaps A or the size of pores B, describes high density without any mention regarding a cover factor, or the like, and does not define the single strand fineness of a microfiber. In this light, the Korean Pa tent Publication No. 10-2002-0035012 is not clear. In addition, it has the same problems as shown in Korean Patent No. 10-0365188 by carrying out a cire processing as a physical pressing to block the pores B.

Korean Patent Publication No. 10-2002-0013679 discloses a high-density micro woven fabric using a microfiber including polyester as a main component and nylon in 30% or less. However, if a single strand fineness of a microfiber woven fabric including nylon in 30% or less is 100 denier or less, it is difficult to weave a fabric having a pore B size of 4 μm or less. Also, the Publication does not clearly define the single strand fineness of the microfiber. In this light, the Publication is not clear. For example, if a single strand fineness of a microfiber is 50 denier or less and a monofilament fineness is 0.3 denier or less, the size of the pores B is 4 μm or greater. Therefore, there is a need to perform a physical pressing process such as a cure processing in order to reduce the size of the pores B.

### DETAILED DESCRIPTION OF THE INVENTION

### Technical Problem

In order to weave a high-density micro fabric for blocking allergens found in our daily lives, the following three requirements should be met. First, the size of gaps A between monofilaments consisting of a stand of a microfiber is required to be far less than the minimum size of excrements of house dust mites, i.e., 10 μm. Second, the size of pores B in warp-weft intersections is also required to be far less than the minimum size of excrements of house dust mites, i.e., 10 μm. Third, the size of the pores B should be permanently reduced with the feeling of the micro fabric being soft by a weaving process without a cure processing as a post-processing. Among these requirements, the second and third requirements are critical and the first requirement can be easily satisfied by piling up monofilaments in the process of weaving a fabric.

### Technical Solution

In order to reduce the size of gaps A between monofilaments to be less than the size of excrements of house dust mites, a monofilament fineness of a nylon microfiber may be 0.97 denier (10 μm) or less, and a monofilament fineness of a polyester microfiber may be 1.04 denier (10 μm) or less. Preferably, a monofilament fineness of a nylon microfiber may be 0.7 denier, and a monofilament fineness of a polyester microfiber may be 0.8 denier or less. Since the monofilaments are piled up and duplicated in the process of weaving a fabric, a woven fabric having the size of the gaps A of 3 μm or less may be obtained if k value defined below is satisfied. In this regard, if the fineness of each monofilament is 0.1 denier or less, the surface area of a fiber increases, and thus it may be difficult to perform a dyeing process, and the generation of static electricity may increase. On the other hand, if the fineness of each monofilament is 1.5 denier or greater, the feeling of the woven fabric may becomes rough and hard.

A high-density woven fabric generally refers to a woven fabric obtained by tightly weaving with increasing the numbers of strands of warp and weft yarns. However, there has been no definition regarding the high-density woven fabric so far and the term has been customarily used. Accordingly, a cover factor k1 (for example, k1 value is 1 when a unit area is filled with a fiber without any gap or pore) is used herein instead of the unclear term ‘high-density’.

The pores B in warp-weft intersections are affected by a single stand fineness of a microfiber and the number of strands per inch and k1 can be represented by the following formula.

k1=(Na×√(Da)×10.81+Nb×√(Db)×9.82+Nc×√(Dc)×9.37)/25400

k1=cover factor

Na=the number of strands of nylon per inch, Da=single strand fineness of nylon (denier)

Nb=the number of strands of polyester per inch, Db=single strand fineness of polyester (denier)

Nc=the number of strands of cotton per inch, Dc=single strand fineness of cotton (denier)

The size of the pores B in warp-weft intersections is reduced as the single strand fineness decreases even though fabrics have the same cover factor. Accordingly, the size of the pores B may be reduced by using a microfiber having a low fineness, and a pore coefficient of a cover factor according to the single strand fineness can be represented by the following formula.

k2=10/(c×√(Da))+10/(c×√(Db))+10/(c×√(Dc))

k2=pore coefficient

c=material constant; nylon=10.81, polyester=9.82, cotton=9.37

Da=single strand fineness of nylon

Db=single strand fineness of polyester

Dc=single strand fineness of cotton

In addition, the present inventors have found that a k value obtained by multiplying k1 by k2 is related to the size of the pores B in warp-weft intersections, and a satisfactory result may be obtained if a value obtained by multiplying k by 100 is 22 or greater based on experience.

k=(k1×k2)×100≧22

According to the present inventors, in case that a monofilament fineness of warp and weft fibers is 0.3 denier or less and a single strand fineness is 100 denier or greater, the cover factor k1 have a considerably high value of about 90%, but k2 is too low, and thus the size of the pores B increases in warp-weft intersections. In this case, theoretically, the k needs to be adjusted to 22 or greater by increasing the values Na, Nb, and Nc of k1, i.e., the number of strands per inch. However, the k cannot be greater than 22 since a fabric having such a high level of density cannot be woven, practically. Accordingly, the k is less than 22, and thus the pores B should be blocked by a physical pressing such as the cire processing. In addition, if the single strand fineness of the warp and weft yarns is less than 5 denier, the yarns are cut by tension caused in the process of weaving the fabric.

When the single strand fineness of either the warp or weft microfiber yarn is 100 denier or less, the k2 has a relatively high value, and thus a satisfactory result may be obtained. For example, a high-density fabric having the k of 22 or greater may be prepared by weaving a fabric using nylon or polyester or composite yarn including nylon and polyester having a fineness of 40 denier as a warp yarn and nylon or polyester or composite yarn including nylon and polyester having a fineness of 120 denier or less as a weft yarn, in which the content of nylon is 30% or greater, and preferably 50% or greater, and dyeing the fabric at a temperature of 95. or higher because of a rapid shrinkage of nylon which is higher in heat shrinkage than polyester. In order to further increase k1, it would be preferable that at least one selected from the group consisting of high shrinkage nylon, a nylon partially oriented yarn (POY), and a nylon spin draw yarn having an elongation at break of 25% or higher may be mixed or arranged with the warp or weft yarn or both of the warp and weft yarns. To obtain the highest shrinkage rate, a water soluble PVA-based yarn is mixed or arranged with the warp or weft yarn or both of the warp and weft yarns, and the PVA-based yarn is removed during a scouring process, or a dyeing process, or the like, after a weaving process. Then, the PVA-based yarn rapidly shrinks while melting, and thus a ultra high-density woven fabric having a high k value in which the size of the pores B is 3.0 μm or less may be obtained. In addition, cotton may be used to improve hygroscopic properties of a woven fabric. If cotton is partially used in both of the warp and weft yarns, or entirely or partially used in either of the warp or weft yarn, the k value is increased and hydroscopic properties of the woven fabric are improved by including at least 30% nylon, by mixing or arranging one among high shrinkage nylon, a nylon partially oriented yarn, or a nylon spin draw yarn having an elongation at break of 25% or higher with the yarns, or by mixing or arranging a water soluble PVA-based yarn and removing the PVA-based yarn in a scouring process or a dyeing process after weaving the fabric.

According to another embodiment, the warp yarn may be nylon, polyester, a composite yarn including nylon and polyester, or cotton, or mixed or arranged with cotton, and the weft yarn may be nylon, polyester, a composite yarn including nylon and polyester, or cotton, or mixed or arranged with cotton. In this regard, the weight ratio of cotton per unit weight of a woven fabric may be 1% or greater.

However, if cotton is partially used in both of the warp and weft yarns, or entirely or partially used in either of the warp or weft yarn, and the content of nylon is less than 30% or spin draw yarn having an elongation at break of less than 25% is mixed or arranged, a fabric does not sufficiently shrink during a scouring process or dyeing process so that the k2 value may be too low and k value may be less than 22.

Relating to an article using the high density micro fabric produced from the foregoing methods, an structure is fabricated by stacking at least two layers including the micro fabric and any other material. A stacked and adhered method of the structure is that because the fabric consists of a thread including an ingredient in at least 0.1% that is fused at 220□ or less during forming embroidery, quilting, sewing, and embossing, a seamed line occurred during forming at least partially includes a portion to be blocked by the fused ingredient by a post-processing, and thus the structure is fabricated. Another stacked and adhered method of the structure is that the structure may be fabricated by including at least one portion of embroidery, quilting, sewing, and embossing which are fused by ultrasonic waves.

An structure including the micro fabric may be fabricated. The structure may include bedding encasements such as bedclothes, padded quilts, and pillows and cover therefor, clothes, fabrics for toys, covers for toys, filters for masks, filters for air cleaners, filters of vacuum cleaners, curtains, covers for furniture, and covers for living merchandise.

### Advantageous Effects

The sizes of the gaps A and the pores B of the high-density micro fabric can be adjusted to be 3 μm or less without any physical pressing and enlargement of the gaps and the pores after repeated washings is prevented. Thus, the high-density micro fabric can have a soft silky feeling which is different from a hard feeling obtained after a cure processing, and thus is efficiently applied to anti-allergen bedding encasements for children.

### BEST MODE

### Example 1

A nylon microfiber having the single strand fineness of 45 denier and consisting of 48 filaments with the monofilament fineness of 0.94 denier was used as a warp yarn, and a polyester microfiber having the single strand fineness of 45 denier and consisting of 48 filaments with a monofilament fineness of 0.94 denier was used as a weft yarn to weave a fabric having a warp density of 150 threads/inch and a weft density of 90 threads/inch. As a result, the weight percent of nylon per unit weight was 62.5%, k1 value was 0.66, k2 value was 0.290, k value was 19.2, and the size of a pore B was 15 μm. The woven fabric was dyed at 95. for 2 hours to have a warp density of 175 threads/inch, a weft density of 122 threads/inch, k1 value of 0.816, k value of 23.6, and sizes of gaps A and pores B of 3 μm or less. Even though not carrying out a cire processing, the fabric had a desired pore size, a soft feeling, and the pore size was maintained after washing the fabric 5 times.

### Example 2

The same warp and weft yarns used in Example 1 were used to weave a fabric, except that the weft yarn was additionally mixed with a nylon partially oriented yarn having the single strand fineness of 10 denier and consisting of 12 filaments. The fabric was fabricated in such manner that the conditions for the warp yarn were the same as those in the Example 1 and the weft yarn had a single strand fineness of 55 denier and included 60 filaments and a weft density of 85 threads/inch after mixing. As a result, the weight percent of nylon per unit weight was 66.5%, k1 value was 0.67, k2 value was 0.272, k value was 18.08, and the size of a pore B was 16 μm. The woven fabric was dyed at 95. for 2 hours to have a warp density of 180 threads/inch, a weft density of 130 threads/inch, k1 value of 0.89, k value of 24.0, and sizes of gaps A and pores B of 3 μm or less. Even though not carrying out a cire processing, the fabric had a desired pore size, a soft feeling, and the pore size was maintained after washing the fabric 5 times.

### Example 3

The same warp and weft yarns used in Example 1 were used to weave a fabric, except that the weft yarn was mixed with a water soluble PVA-based yarn having the single strand fineness of 5 denier and consisting of 10 filaments. The fabric was fabricated in such manner that the conditions for the warp yarn were the same as that of Example 1 and the weft yarn had the single strand fineness of 50 denier and included 58 filaments. a weft density of 85 threads/inch after mixing. As a result, a weight percent of nylon per unit weight was 59.1%, k1 value was 0.67, k2 value was 0.272, k value was 18.08, and the size of a pore B was 13 μm. When the woven fabric was dyed at 95. for 2 hours, the PVA-based yarn was dissolved in water and removed, and thus the fabric significantly shrank. Accordingly, the fabric had a warp density of 190 threads/inch, a weft density of 140 threads/inch, k1 value of 0.94, k value of 25.5, and sizes of gaps A and pores B of 3 μm or less. Even though not carrying out a cure processing, the fabric had a desired pore size, a soft feeling, and the pore size was maintained after washing the fabric 5 times.

### Example 4

A nylon microfiber having a single strand fineness of 30 denier and consisting of 34 filaments with a monofilament fineness of 0.88 denier was used as a warp yarn, and a polyester microfiber having a single strand fineness of 30 denier and consisting of 72 filaments with a monofilament fineness of 0.42 denier was used as a weft yarn to weave a fabric having a warp density of 170 threads/inch and a weft density of 100 threads/inch. As a result, the weight percent of nylon per unit weight was 62.9%, k1 value was 0.57, k2 value was 0.355, k value was 20.2, and the size of a pore B was 16 μm. The woven fabric was dyed at 120. for 40 minutes to have a warp density of 212 threads/inch, a weft density of 128 threads/inch, k1 value of 0.72, k value of 25.5, and sizes of gaps A and pores B of 3 μm or less. Even though not carrying out a cire processing, the fabric had a desired pore size, a soft feeling, and the pore size was maintained after washing the fabric 5 times.

### Example 5

A nylon microfiber having a single strand fineness of 30 denier and consisting of 34 filaments with a monofilament fineness of 0.88 denier was used as a warp yarn, and a cotton microfiber having a single strand fineness of 50 denier and consisting of 50 fibers with a monofiber fineness of 1 denier was used as a weft yarn to weave a fabric having a warp density of 170 threads/inch and a weft density of 90 threads/inch. As a result, a weight percent of nylon per unit weight was 51.7%, k1 value was 0.64, k2 value was 0.315, k value was 20.0, and the size of a pore B was 17 μm. The woven fabric was dyed at 110. for 1 hour to have a warp density of 212 threads/inch, a weft density of 120 threads/inch, k1 value of 0.82, k value of 25.7, and sizes of gaps A and pores B of 3 μm or less Even though not carrying out a cire processing, the fabric had a desired pore size, a soft feeling, and the pore size was maintained after washing the fabric 5 times.

### Comparative Example 1

A polyester microfiber having a single strand fineness of 45 denier and consisting of 48 filaments with a monofilament fineness of 0.94 denier was used as a warp yarn, and a polyester microfiber having a single strand fineness of 45 denier and consisting of 48 filaments with a monofilament fineness of 0.94 denier was used as a weft yarn to weave a fabric having a warp density of 150 threads/inch and a weft density of 90 threads/inch. As a result, a weight percent of nylon per unit weight was 0%, k1 value was 0.62, k2 value was 0.303, k value was 18.8, and the size of a pore B was 15 μm. The woven fabric was dyed at 120. for 1 hour to have a warp density of 162 threads/inch, a weft density of 98 threads/inch, k1 value of 0.674, k value of 20.4, and sizes of gaps A and pores B ranging from 10 μm to 14 μm. Thus, excrements of house dust mites might pass through the fabric.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A high-density micro fabric,
wherein a single strand fineness of either of a warp or weft yarn or both of the warp and weft yarns is in the range of 5 denier to 100 denier,
a fineness of a monofilament constituting one strand of either of a warp or weft yarn or both of the warp and weft yarns is in the range of 0.1 denier to 1.5 denier,
the warp yarn is nylon, polyester, or a composite yarn comprising nylon and polyester, and the weft yarn is nylon, polyester, or a composite yarn comprising nylon and polyester, and
a high shrinkage nylon yarn, a nylon partially oriented yarn, a nylon spin draw yarn having an elongation at break of 25% or higher, or a water soluble PVA-based yarn that is dissolved and removed by water during a scouring process or a dyeing process is mixed or arranged with either of the warp or weft yarn, and
k value of a shrunken fabric is 22 or greater.

2. A high-density micro fabric,
wherein a single strand fineness of either of a warp or weft yarn or both of the warp and weft yarns is in the range of 5 denier to 100 denier,
a fineness of a monofilament constituting one strand of either of a warp or weft yarn or both of the warp and weft yarns is in the range of 0.1 denier to 1.5 denier,
the warp yarn is nylon, polyester, or a composite yarn comprising nylon and polyester, and the weft yarn is nylon or a composite yarn comprising nylon and polyester in case that polyester is used as the warp yarn and the weft yarn is nylon, polyester, or a composite yarn comprising nylon and polyester in case that nylon, or a composite yarn composing nylon and polyester is used as the warp yarn, and
the weight percent of nylon per unit weight of a shrunken fabric is 30% or greater and k value of the shrunken fabric is 22 or greater.

3. A high-density micro fabric,
wherein a single strand fineness of either of a warp or weft yarn or both of the warp and weft yarns is in the range of 5 denier to 100 denier,
a fineness of a monofilament constituting one strand of either of a warp or weft yarn or both of the warp and weft yarns is in the range of 0.1 denier to 1.5 denier when the warp and weft yarns are nylon, polyester, or a composite yarn comprising nylon and polyester and 0.1 denier to 3 denier when the warp and weft yarns are cotton,
the warp is nylon, polyester, a composite yarn comprising nylon and polyester, or cotton, or a mixture or arrangement of the nylon or the composite yarn and the cotton, and the weft is nylon, polyester, a composite yarn comprising nylon and polyester, or cotton, or a mixture or arrangement of the nylon, the polyester or the composite yarn and the cotton, and
a high shrinkage nylon yarn, a nylon partially oriented yarn, a nylon spin draw yarn having an elongation at break of 25% or higher, or a water soluble PVA-based yarn that is dissolved and removed by water during a scouring process or a dyeing process is mixed or arranged with either of a warp or weft yarn or both of the warp and weft yarns,
the weight percent of cotton per unit weight of a shrunken fabric is 1% or greater, and
k value of the shrunken fabric is 22 or greater.

4. A high-density micro fabric,
wherein a single strand fineness of either of a warp or weft yarn or both of the warp and weft yarns is in the range of 5 denier to 100 denier,
a fineness of a monofilament constituting one strand of either of a warp or weft yarn or both of the warp and weft yarns is in the range of 0.1 denier to 1.5 denier when the warp and weft yarns are nylon, polyester, or a composite yarn comprising nylon and polyester and 0.1 denier to 3 denier when the warp and weft yarns are cotton,
the warp is nylon, polyester, a composite yarn comprising nylon and polyester, or cotton, or a mixture or arrangement of the nylon or the composite yarn and the cotton, and the weft is nylon or a composite yarn comprising nylon and polyester, or cotton, or a mixture or arrangement of the nylon or the composite yarn and the cotton in case that polyester or cotton is used as the warp and the weft is nylon, polyester, a composite yarn comprising nylon and polyester, or cotton, or a mixture or arrangement of the nylon, the polyester or the composite yarn and the cotton in case that nylon or the composite yarn comprising nylon and polyester is used as the warp,
the weight percent of nylon per unit weight of a shrunken fabric is 30% or greater,
the weight percent of cotton per unit weight of the shrunken fabric is 1% to 70%, and
k value of the shrunken fabric is 22 or greater.

5. A structure fabricated by stacking at least two layers comprising a micro fabric according to claim 1 and any other material.

6. A structure fabricated by stacking at least two layers comprising a micro fabric according to claim 2 and any other material.

7. A structure fabricated by stacking at least two layers comprising a micro fabric according to claim 3 and any other material.

8. A structure fabricated by stacking at least two layers comprising a micro fabric according to claim 4 and any other material.

9. A structure wherein a fabric consists of threads including an ingredient in at least 0.1% that is fused at 220□ or less during forming embroidery, quilting, sewing, and embossing in stacking of claim 5, the weight percent of the ingredient per unit weight of the threads being at least 0.1% and a seamed line occurred during forming at least partially includes a portion to be blocked by the fused ingredient by a post-processing, and thus the structure is fabricated.

10. A structure wherein a fabric consists of threads including an ingredient in at least 0.1% that is fused at 220□ or less during forming embroidery, quilting, sewing, and embossing in stacking of claim 6, the weight percent of the ingredient per unit weight of the threads being at least 0.1% and a seamed line occurred during forming at least partially includes a portion to be blocked by the fused ingredient by a post-processing, and thus the structure is fabricated.

11. A structure wherein a fabric consists of threads including an ingredient in at least 0.1% that is fused at 220□ or less during forming embroidery, quilting, sewing, and embossing in stacking of claim 7, the weight percent of the ingredient per unit weight of the threads being at least 0.1% and a seamed line occurred during forming at least partially includes a portion to be blocked by the fused ingredient by a post-processing, and thus the structure is fabricated.

12. A structure wherein a fabric consists of threads including an ingredient in at least 0.1% that is fused at 220□ or less during forming embroidery, quilting, sewing, and embossing in stacking of claim 8, the weight percent of the ingredient per unit weight of the threads being at least 0.1% and a seamed line occurred during forming at least partially includes a portion to be blocked by the fused ingredient by a post-processing, and thus the structure is fabricated.

13. A structure comprising at least one portion of embroidery, quilting, sewing, and embossing which are fused by ultrasonic waves in stacking of claim 5.

14. A structure comprising at least one portion of embroidery, quilting, sewing, and embossing which are fused by ultrasonic waves in stacking of claim 6.

15. A structure comprising at least one portion of embroidery, quilting, sewing, and embossing which are fused by ultrasonic waves in stacking of claim 7.

16. A structure comprising at least one portion of embroidery, quilting, sewing, and embossing which are fused by ultrasonic waves in stacking of claim 8.

17. A structure comprising a micro fabric according to claim 1, wherein the structure comprises bedding encasements such as bedclothes, padded quilts, and pillows and cover therefor, clothes, fabrics for toys, covers for toys, filters for masks, filters for air cleaners, filters of vacuum cleaners, curtains, covers for furniture, and covers for living merchandise.

18. A structure comprising a micro fabric according to claim 2, wherein the structure comprises bedding encasements such as bedclothes, padded quilts, and pillows and cover therefor, clothes, fabrics for toys, covers for toys, filters for masks, filters for air cleaners, filters of vacuum cleaners, curtains, covers for furniture, and covers for living merchandise.

19. A structure comprising a micro fabric according to claim 3, wherein the structure comprises bedding encasements such as bedclothes, padded quilts, and pillows and cover therefor, clothes, fabrics for toys, covers for toys, filters for masks, filters for air cleaners, filters of vacuum cleaners, curtains, covers for furniture, and covers for living merchandise.

20. A structure comprising a micro fabric according to claim 4, wherein the structure comprises bedding encasements such as bedclothes, padded quilts, and pillows and cover therefor, clothes, fabrics for toys, covers for toys, filters for masks, filters for air cleaners, filters of vacuum cleaners, curtains, covers for furniture, and covers for living merchandise.
